(19) United States
(12) Patent Application Publication
(10) Pub. No.: US 2004/0198221 A1
(43) Pub. Date: Oct. 7, 2004

(54) Wireless communication module capable of waking up a wireless communication device in park mode based on connectionless broadcast and method thereof

(75) Inventors: Zhen Bin, Suwon-city (KR); Yong-suk Kim, Daejeon-city (KR)

Correspondence Address: SUGHRUE MION, PLLC, 2100 Pennsylvania Avenue, N.W., Washington, DC, 20037-3213, US

(73) Assignee: SAMSUNG ELECTRONICS CO., LTD.

(21) Appl. No.: 10/234,852

(22) Filed: Sep. 5, 2002

(30) Foreign Application Priority Data
Mar. 6, 2002 (KR) 2002-61018

(51) Int. Cl. H04B 5/00; H04M 1/00; H04B 1/38

(52) U.S. Cl. 455/41.1; 455/574

(57) ABSTRACT

Disclosed is a wireless communication module capable of waking up a wireless communication device in a park state based on a connectionless broadcast and a method thereof. A synchronization information transmitting unit broadcasts synchronization information that includes an address of a personal area network user (PANU) and a clock information. A parameter setting unit sets window parameters that include size and repetition of a random access window. An information generation unit generates a window supporting information indicative of whether a random access window is supported or not. A window management unit activates and inactivates a polling access window and a random access window generated based on the window parameters. The PANU, which is synchronized using the synchronization information, is unparked through the random access window based on the window supporting information.

### BACKGROUND OF THE INVENTION

1. Field of the Invention

The present invention generally relates to a wireless communication module capable of waking up a wireless communication device in park mode based on connectionless broadcast and a method thereof, and more particularly, the present invention relates to a wireless communication module capable of waking up a bluetooth device in a park mode into an active mode for communication activity, when the bluetooth device is moved from one piconet to another piconet, and a waking method thereof used in park mode.

2. Description of the Prior Art

PAN Users (PANUs) supporting personal area network (PAN) profile can switch from active mode to park mode by their own needs or by a master device.

A conventional wake up channel for waking up the PANU in park mode consists of a beacon slot and an access window. According to the Bluetooth standard, the PANU in park mode can be switched to the active mode through the use of polling access technique. Device in park mode is only allowed to request the master for a mode switch when the connection window is open, and is switched to the active mode by a polling message received from the master.

A problematic situation can occur in the waking up of the PANU, which has moved from one piconet to another piconet. Having synchronized to the previous master of one piconet, the PANU tries switching into active mode in accordance with the clock of the previous master. However, as another piconet, to which the PANU has moved, is operated in accordance with the clock of the master of its own, the PANU cannot enter the active mode. Therefore, a method for establishing a direct connection with the new master is required to enable the PANU to enter the active mode.

Meanwhile, when the PANU moves from one piconet to another piconet, the PANU takes a connection establishment process to join in the new piconet so as to have data transmission in the new piconet. The Bluetooth PAN working group and the local positioning working group mentioned about the needs of the exchange and broadcasting of information in great volume before master and slaves are determined.

PANUs gather position information from the network access points (NAP) supporting the PAN profile. Also, as the number of PANUs of the respective NAPs varies according to the movement of the PANUs, NAPs need to broadcast OSI L2 data link layer information and L3 network layer information periodically.

Under the Bluetooth standard 1.1, the bluetooth device is connection-oriented system, which requires great amount of time for the establishment of connection performed before the data transmission. Data broadcasting is performed after the establishment of connection among the PANUs. Further, a great volume of wireless resources need to be used for the handover when the PANU is moved from one piconet to another piconet. For example, several NAPs need to perform paging for a handover of only one PANU during a voluntary handover, leaving a greater number of PANUs being cut with services they have been receiving.

Such cut-off of services to some of the other PANUs sometimes causes failure of real-time service support. As most of PANUs are in idle mode, it can be waste if handover is performed every time PANU is moved. Because, for NAP, it is sufficient to know the rough information about position of the PANU in an idle mode.

However, as the data broadcasting is only enabled under the situation where the piconet of master and slaves is determined in the bluetooth system, a method for supporting broadcast is required prior to the process of connection establishment.

For this, Phillips proposed to extend ID packet to broadcast position information during the inquiry process. The extension of ID packet, however, has a problem when the broadcast information is divided into several packets and transmitted. The position information of the extended ID packet (EID) is as much as 300 bytes, and the access points (AP) need to broadcast the advertisement message periodically according to the IP hierarchal handover protocol. Accordingly, the question is, how the broadcast messages are arranged in an efficient manner.

Meanwhile, according to the extension of ID packet, packet of each slot has to be repeated at intervals of 16 hopping frequency, which means lengthy time has to be spent. Further, as the EID packet has to be received, information receipt is additionally performed together with the synchronization to the NAP. Accordingly, even one ID packet is received in error, information included in the ID packet is lost, and the entire broadcast information can not be reconstructed.

In an attempt to overcome such problem, the Widcomm proposed to add bluetooth device address (BD_ADDR) and clock information of the NAP to the EID packet. By the Widcomm, the PANU in receipt of the ID packet can synchronize to a corresponding NAP using the BD_ADDR and clock information included in the received ID packet. Accordingly, a handover can be performed fast. However, as the PANU needs to response to the received packet for an establishment of connection, still lots of time have to be spent until the data transmission.

### SUMMARY OF THE INVENTION

Accordingly, it is an object of the present invention to provide a wireless communication module capable of waking up in a park mode based on connectionless broadcast, and a wakeup method of a wireless communication device.

The above object is accomplished by a wireless communication module according to the present invention, including a parameter setting unit for setting window parameters including size and repetition of a random access window; an information generation unit for generating window supporting information indicative of whether the random access window is supported or not; and a window management unit for activating and inactivating a polling access window and the random access window generated based on the window parameters.

The window supporting information is transmitted through a beacon slot. The polling access window and the random access window are activated after the beacon slot through which the window supporting information is transmitted.

Information about the activation is accomplished by a link management protocol.

The poling access window and the random access window are activated simultaneously.

Alternatively, the polling access window and the random access window are activated at a predetermined time interval by a sequential order. Accordingly, the window parameters further include the predetermined time interval.

The random access window consists of a plurality of slots, which support a synchronization connection-oriented link.

Further provided is a wakeup unit for transmitting a wakeup message to an external communication device in response to the window supporting information, when received with a connection request message from the external communication device. The connection request message comprises an address of a personal area network user (PANU) of the external communication device. The connection request message is received after a certain number of time slots, the certain number corresponding to one between 0 and size of random access window×2.

The wakeup unit comprises the address of the PANU of the external communication device when there is a packet to be transmitted to the external communication device. The wakeup message is transmitted through a beacon slot.

Further provided are: a synchronization information transmitting unit for broadcasting a synchronization information that includes an address of a personal area network user (PANU) and a clock information; and a packet transmitting unit for transmitting a broadcast data packet after the transmission of the synchronization information, the broadcast data packet including a channel access code, a packet header and a payload. The window management unit activates the polling access window and the random access window after the transmission of the synchronization information and the broadcast data packet.

According to the present invention, a method for waking up a wireless communication device in a park mode comprises the steps of: transmitting a window supporting information indicative of whether a random access window is supported or not; activating a polling access window and the random access window generated based on a predetermined window parameter; receiving an access request from an external communication device through the random access window; and transmitting an upnarking message to the external communication device.

The window supporting information is transmitted through a beacon slot. The polling access window and the random access window are activated after the beacon slot through which the window supporting information is transmitted.

Information about the activation is accomplished by a link management protocol.

The poling access window and the random access window are activated simultaneously. Alternatively, the polling access window and the random access window can be activated at a predetermined time interval by a sequential order. In this case, the window parameters further include the predetermined time interval.

The random access window consists of a plurality of slots, which support a synchronization connection-oriented link.

The connection request message is received after a certain number of time slots, the certain number corresponding to one between 0 and size of random access window×2.

Further provided is the step of transmitting the wakeup message inclusive of the address of the PANU of the external communication device through the beacon slot, when there is a packet to be transmitted to the external communication device.

Further provided is the step of synchronizing the external communication device prior to the step of transmitting the window supporting information. The synchronization step comprises the steps of: broadcasting a synchronization information that includes an address of a personal area network user (PANU) and a clock information; and transmitting a broadcast data packet that includes a channel access code, a packet header and a payload after the transmission of the synchronization information.

### BRIEF DESCRIPTION OF THE DRAWINGS

The above-mentioned object and the feature of the present invention will be more apparent by describing the preferred embodiment of the present invention in detail referring to the appended drawings, in which:

FIG. 1 is a block diagram showing the structure of a bluetooth module capable of waking up in a park mode based on connectionless broadcast according to a preferred embodiment of the present invention;

FIG. 2 is a view showing the structure of the connectionless wakeup channel;

FIG. 3 is a view showing hierarchical structure and time information of the broadcast channel;

FIG. 4 is a flowchart showing the processes of wakeup method for waking up PANU in park mode in bluetooth system based on connectionless broadcast according to the present invention; and

FIG. 5 is a flowchart showing the process of the PANU synchronized to a new NAP after moving.

### DETAILED DESCRIPTION OF PREFERRED EMBODIMENT

The present invention will be described in greater detail with reference to the accompanying drawings. The like elements will be given the same reference numerals as in the prior art throughout the description.

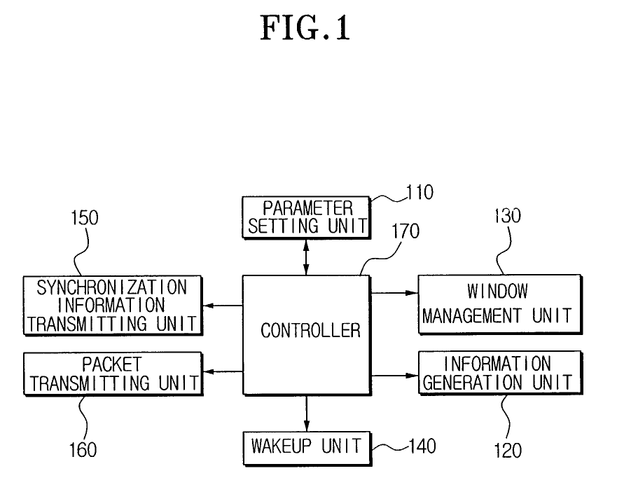

FIG. 1 is a block diagram showing the structure of a bluetooth module capable of waking up in park mode based on connectionless broadcast according to one preferred embodiment of the present invention.

Referring to FIG. 1, the bluetooth module 100 according to the present invention includes a coefficient setting unit 110, an information generation unit 120, a window management unit 130, a wakeup unit 140, a synchronization information unit 150, a packet transmitting unit 160, and a controller 170.

The parameter setting unit 110 sets window parameters inclusive of size and repetition of random access window. The parameters are determined when the information about wakeup channel is broadcasted through the connectionless broadcast channel.

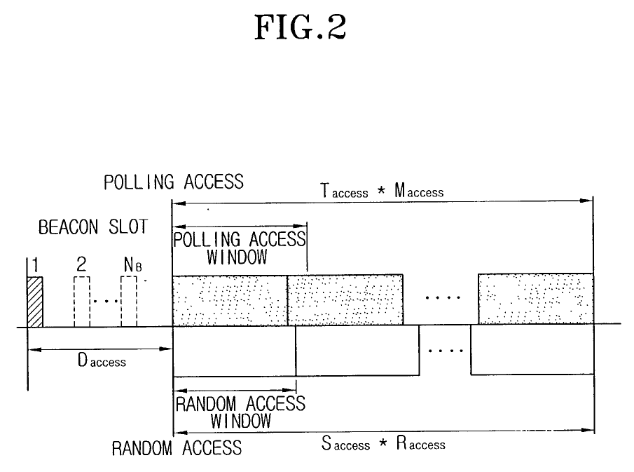

FIG. 2 shows the structure of connectionless wakeup channel.

In FIG. 2, parameters S_{access} and R_{access} describe the size and repetition of random access window respectively. The random window access and polling access window can coexist because of different re-transmission mechanisms. The polling access window and random access window may have different start slot. If the start slot is different, another parameter that describes the offset of random access window is needed. Slave and master slots of the interval of random access window are 312.5 μs respectively.

The information generation unit 120 generates window support information as to whether he random access window is supported or not. The window supporting information is transmitted through beacon slot. In addition to the existing functions, the beacon slot is provided with additional functions like notification of random access window (non)support, and unparking of parked PANU. These additional functions are realized by the new link management protocol (LMP) message. Without the LMP message that indicates that the random access window is supported, the parked connectionless PANU cannot use the random access interval. The PANU in receipt of corresponding LMP message in the beacon slot, enters the active mode.

Meanwhile, as traffic is received from the backbone to the parked connectionless PANU, the NAP sends wakeup LMP message, inclusive of BD_ADDR of corresponding PANU, in the beacon slot. In such a situation, a new NAP generates wakeup message using the BD_ADDR of corresponding PANU, because the parked connectionless PANU does not know the access request address (AR_ADDR) allocated by the new NAP.

The window management unit 130 activates and inactivates polling access window and the random access window generated based on the window parameters. If the LMP message indicating that the NAP supports the random access is transmitted in the beacon slot, the parked connectionless PANUs can voluntarily request the NAP for unparking using the random access interval.

The PANU generates a random number RAND between 0 and 2×S_{access}. Then the PANU waits for duration of RAND half time slots from the beginning of random access window. After RAND half time slots, the PANU responses an EID packet, including BD_ADDR only, in upper slot.

The wakeup unit 140 transmits the wakeup message to the PANU in response to the window support information when there is a message of connection request received from the PANU. After having transmitted the EID packet, the PANU waits for the wakeup LMP message from the NAP. If the wakeup message is received, the PANU enters active mode. Meanwhile, if the unpack message is not received until the end of the random access window, the PANU re-requests for the unpark in the next random access window.

Slots of the random access window can support SCO link. Like the polling access window system, the PANUs are allowed to transmit access requesting packet through the upper slot only in receipt of broadcast packet from the lower slot. As the SCO packet is not a broadcast packet, the PANU withdraws a request for unpark in the next upper slot when it receives the SCO packet. Meanwhile, when the next lower slot is reserved as the SCO packet, the NAP does not transmit the wakeup message.

The synchronization information transmitting unit 150 broadcasts synchronization information that includes address and clock information of the PANU. The synchronization information is transmitted through the beacon window.

After having transmitted the synchronization information, the packet transmitting unit 160 transmits the broadcast data packet that includes channel access code, packet header and payload. The broadcast data packet is transmitted through the broadcast window.

The beacon window and the broadcast window construct a connectionless broadcast channel. As specified in the existing Bluetooth standards, the beacon window is used for channel synchronization between the sender and receiver, while the broadcast window is used for a transmission of broadcast information. The PANU is merely in the inquiry-scan state to receive the broadcast information.

The controller 170 controls operation of the respective units. The controller 170 can be formed in the bluetooth module 100, or otherwise, can be formed in a host (not shown) that drives the bluetooth module 100.

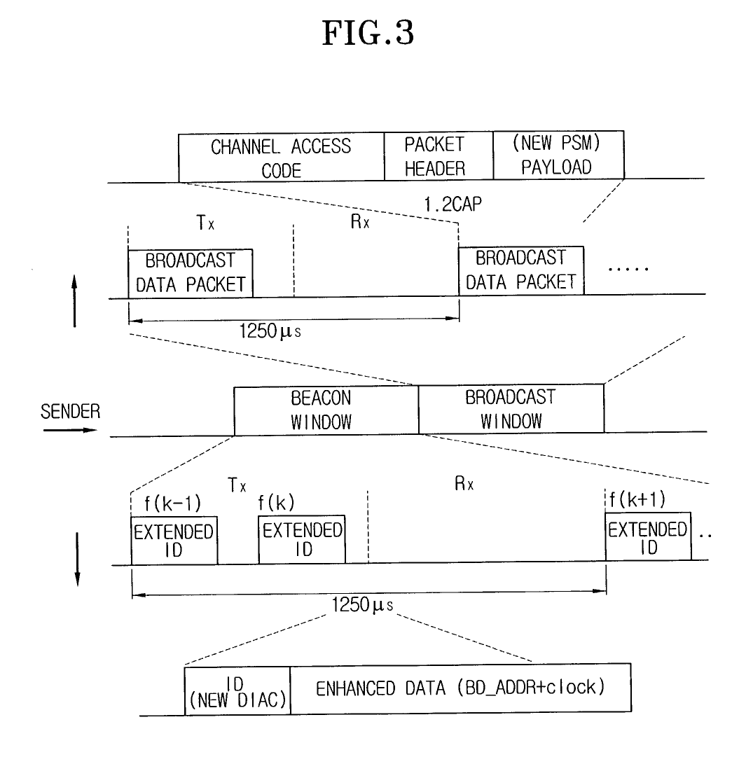

FIG. 3 shows the hierarchical structure of the broadcast channel and time information. Process similar to the inquiry process is performed in the beacon window, and the broadcast information transmitted during the broadcast window is transmitted as it is broadcasted in one piconet. As the PANU needs not response to any form of received packet during the beacon window and the broadcast window, there is no need for a connection set-up. Accordingly, the broadcast channel proposed by the present invention has the connectionless characteristic.

Synchronization in the beacon window is performed using the EID packet of the Phillips, and for the purpose of distinguishing the EID packet from the ID packet of the NAP, newly defined dedicated inquiry access code (DIAC) is used. Table 1 below lists information included in the EID.

TABLE 1

| Fields | Items | Size | Comments |
|---|---|---|---|
| Service | Type | 4 bits | Synchronization packet & |
| | | | random access request |
| | | | packet (2 bits are reserved) |
| Synchronization | Clock | 28 bits | |
| | BD_ADDR | 32 bits | |
| Broadcast window | Offset slots | 21 bits | Optional |
| configuration | Broadcast | 5 bits | |
| | window size | 3 bits | |
| | Broadcast | | |
| | repetition | | |
| Error check | CRC | 8 bits | FEC rate 2/3 |

The information of service type, BD_ADDR and CRC are mandatory. If broadcast window immediately follows the beacon window, the ‘offset slot’ can be optional. The other information is optional.

The broadcast information transmitted in the broadcast window can vary depending on the type of application in use. In other words, position information can be transmitted through the broadcasting information, or advertisement information from OSI L2 and L3. In the absence of the broadcast information, the broadcast widow can be omitted.

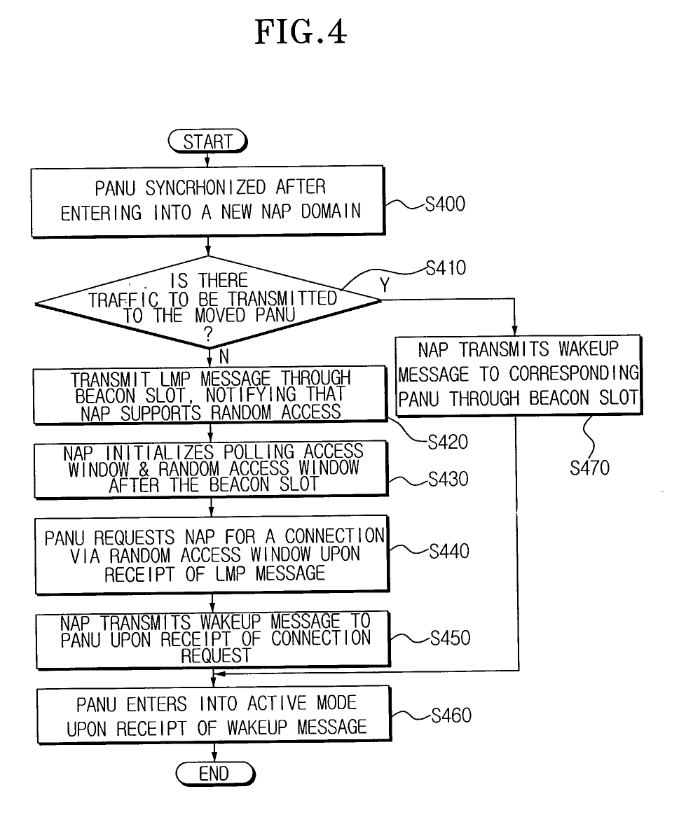

FIG. 4 is a flowchart showing the process of waking up the PANU in park mode in the bluetooth system based on connectionless broadcast according to the preferred embodiment of the present invention.

Referring to FIG. 4, in receipt of a new NAP identifier, the PANU in parked mode determines that it has moved to a new NAP domain and accordingly performs a synchronization (step S40). During the broadcast window, the NAP broadcasts information related to set values for connectionless park mode, advertisement message, NAP identifier, set values of the wakeup channel, etc.

In the beginning of the wakeup channel, the PANU is changes its frequency hopping pattern to the frequency hopping pattern of the synchronized NAP, and waits for the LMP message. When there is no traffic transmitted to the PANU, which has moved, (step S410), the NAP transmits a LMP message to the PANU indicating that it supports random access (step S420). At the end of the beacon slot, the NAP wakes up the polling access window and the random access window (step S430). The PANU, in receipt of LMP message, either updates position information or transmits an access request to the NAP through the random access window by using the EID packet (step S440). When the NAP receives the EID from the PANU, the NAP transmits a wakeup message (step S450). In receipt of wakeup message, the PANU enters active mode, thereby becoming a new active participant of the NAP (step S460).

When the NAP tries to page the PANU (step S410), the NAP transmits wakeup message to the corresponding PANU through the beacon slot (step S470). In receipt of wakeup message, the PANU enters active mode (step S460).

It is the poll message that the PANU entering the active mode receives first from the NAP, and the PANU must response to the poll message (step S480). When the response to the poll message reaches the NAP, the NAP establishes a BNEP connection, thereby enabling data transmission (step S49).

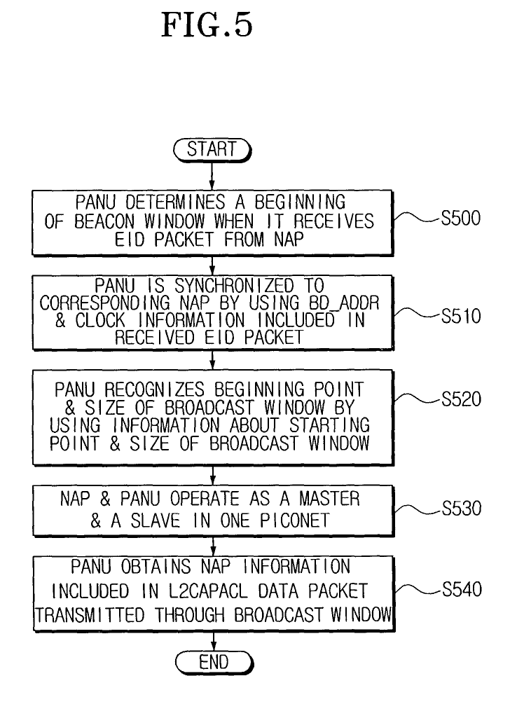

FIG. 5 is a flowchart showing the process of the moved PANU synchronizing to the new NAP.

Through the initial connection establishment, the PANU is connected to the slave of the NAP. If there is no traffics follow, the PANU stays in park mode. The NAP broadcasts EID packet in the beacon window, and the PANUs in inquiry scan sub-state receives the EID packets transmitted from the NAPs.

In beacon window, the NAP acts as in inquiry sub-state, and uses EID packet trains A and B as in the inquiry process. The PANU in inquiry scan mode listens at one hopping frequency, and determines the start of the beacon window when the EID packet is received (step S500). After receiving the EID packet, the PANU synchronizes to the NAP using the BD_ADDR and clock information included in the received EID packet (step S510). The PANU also determines the start point and size of the broadcast window using the start point and size information of the broadcast window, and awaits the start of the broadcast window (step S520). If a standard ID packet is received, the PANU recognizes it as a usual inquiry process, and response accordingly.

If the NAP and the PANU synchronizes with each other using the EID packet in the beacon window, the NAP and the PANU operate as master and slave in one piconet respectively (step S530). After the synchronization, the NAP and PANU have the same frequency hopping pattern. Accordingly, an ACL data packet can be used for transmitting broadcast information. One packet can be repeatedly sent, or the PANU can receive the segmented ACL data packets and reassemble them. The PANU can also destroy the broadcast information that is unidentifiable. The PANU receives the L2CAP ACL data packet transmitted from the NAP through the broadcast window (step S540). Based on the received L2CAP ACL data packet, the PANU knows the information about NAP.

The NAP and the PANU participated in the broadcast channel return to original state after the broadcast window. The broadcast channel can support SCO service by interleaving the SCO reserved slot with inquiry slot and broadcast data slot. Further, as there is no need for the PANU to separately perform connection establishment, the PANU in any modes, namly sniff mode, hold mode, park mode or active mode, can synchronize to the corresponding NAP and receive broadcast information when the PANU receives the DIAC supporting the broadcast channel. By using such characteristic, one PANU can receive information from several NAPs, and perform fast handover using the received information.

Table 2 summarizes the operation of the wireless communication device in park mode to wake up.

TABLE 2

| | | | | | Access | |
|---|---|---|---|---|---|---|
| | | | | | code | |
| | | | | | and | |
| Stage | Step | Message | Direction | Window | hopping | Comment |
| 1 (broadcast | 1 | Extended ID | NAP-> | Beacon | Inquiry | Non- |
| channel) | | | PANU | window | | synchronized, |
| | | | | | | repetition |
| | 2 | L2CAP data | NAP-> | Broadcast | NAP | synchronized, |
| | | | PANU | window | | repetition |
| | 1 | LMP unpnark | NAP-> | Beacon | NAP | Connectionless |
| | | command | PANU | slot | | park mode |
| | | (BD_ADDR) | | | | |
| | 1 | LMP random | NAP-> | Beacon | NAP | Connectionless |
| | | access | PANU | slot | | park mode |
| | | support | | | | (repetition may |
| | | command | | | | be from 2 to 4) |
| | 2 | NULL | NAP-> | Random | NAP | |
| | | | PANU | access | | |
| | | | | window | | |
| | 3 | FHS or EID | NAP <- | Random | NAP | |
| | | (BD_ADDR) | PANU | access | | |
| | | | | window | | |
| | 4 | LMP unpark | NAP-> | Random | NAP | |
| | | command | PANU | access | | |
| | | BD_ADDR | | window | | |
| | 1 | POLL | NAP-> | | NAP | Active mode, |
| | | | PANU | | | connection |
| | 2 | 1st slave | NAP<- | | NAP | confirm |
| | | packet | PANU | | | |

Referring to table 2, in stage 1, the NAP and the PANU synchronizes with each other through the broadcast channel. After the synchronization, the PANU is unparked either through the stage 2-1 by the NAP or through the stage 2-2 by the PANU. Through the stage 3, the unparked PANU participates in the network managed by the new NAP, transmitting and receiving data.

According to the present invention, time for establishing connection between the PANU and the NAP can be shortened, and more than one PANU can be unparked simultaneously. Further, when the PANU existing in one piconet moves to another piconet, as there is no paging process unless there is traffic to be transmitted to the PANU, the entire traffic is reduce. Further, as the PANU in park mode transmits the request message through the random access window only when the ACL data packet is transmitted, reduction of time and traffic is obtained.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A wireless communication module, comprising:
a parameter setting unit for setting window parameters including size and repetition of a random access window;
an information generation unit for generating window supporting information indicative of whether the random access window is supported or not; and
a window management unit for activating and inactivating a polling access window and the random access window generated based on the window parameters.

2. The wireless communication module of claim 1, wherein the window supporting information is transmitted through a beacon slot.

3. The wireless communication module of claim 2, wherein the polling access window and the random access window are activated after the beacon slot through which the window supporting information is transmitted.

4. The wireless communication module of claim 1, wherein information about the activation is accomplished by a link management protocol.

5. The wireless communication module of claim 1, wherein the poling access window and the random access window are activated simultaneously.

6. The wireless communication module of claim 1, wherein the window parameters further include a predetermined time interval, and the polling access window and the random access window are activated at the predetermined time interval by a sequential order.

7. The wireless communication module of claim 1, wherein the random access window consists of a plurality of slots, which support a synchronization connection-oriented link.

8. The wireless communication module of claim 1, further comprising a wakeup unit for transmitting a wakeup message to an external communication device in response to the window supporting information, when received with a connection request message from the external communication device.

9. The wireless communication module of claim 8, wherein the connection request message comprises an address of a personal area network user (PANU) of the external communication device.

10. The wireless communication module of claim 8, wherein the connection request message is received after a certain number of time slots, the certain number corresponding to one between 0 and size of random access window×2.

11. The wireless communication module of claim 8, wherein the wakeup unit comprises the address of the PANU of the external communication device when there is a packet to be transmitted to the external communication device.

12. The wireless communication module of claim 11, wherein the wakeup message is transmitted through a beacon slot.

13. The wireless communication module of claim 1, further comprising:
a synchronization information transmitting unit for broadcasting a synchronization information that includes an address of a personal area network user (PANU) and a clock information; and
a packet transmitting unit for transmitting a broadcast data packet after the transmission of the synchronization information, the broadcast data packet including a channel access code, a packet header and a payload, wherein
the window management unit activates the polling access window and the random access window after the transmission of the synchronization information and the broadcast data packet.

14. The wireless communication module of claim 13, wherein the synchronization information and the broadcast data packet are transmitted respectively through a beacon window and a broadcast window.

15. A method for waking up a wireless communication device in a park mode, comprising the steps of:
transmitting a window supporting information indicative of whether a random access window is supported or not;
activating a polling access window and the random access window generated based on a predetermined window parameter;
receiving an access request from an external communication device through the random access window; and
transmitting an upnarking message to the external communication device.

16. The wakeup method of claim 15, wherein the window supporting information is transmitted through a beacon slot.

17. The wakeup method of claim 15, wherein the polling access window and the random access window are activated after the beacon slot through which the window supporting information is transmitted.

18. The wakeup method of claim 15, wherein information about the activation is accomplished by a link management protocol.

19. The wakeup method of claim 15, wherein the poling access window and the random access window are activated simultaneously.

20. The wakeup method of claim 15, wherein the window parameters further include a predetermined time interval, and the polling access window and the random access window are activated at the predetermined time interval by a sequential order.

21. The wakeup method of claim 15, wherein the random access window consists of a plurality of slots, which support a synchronization connection-oriented link.

22. The wakeup method of claim 15, wherein the connection request message comprises an address of a personal area network user (PANU) of the external communication device.

23. The wakeup method of claim 22, wherein the connection request message is received after a certain number of time slots, the certain number corresponding to one between 0 and size of random access window×2.

24. The wakeup method of claim 15, further comprising the step of transmitting the wakeup message inclusive of the address of the PANU of the external communication device through the beacon slot, when there is a packet to be transmitted to the external communication device.

25. The wakeup method of claim 15, further comprising the step of synchronizing the external communication device prior to the step of transmitting the window supporting information.

26. The wakeup method of claim 25, wherein the synchronization step comprises the steps of:
broadcasting a synchronization information that includes an address of a personal area network user (PANU) and a clock information; and
transmitting a broadcast data packet that includes a channel access code, a packet header and a payload after the transmission of the synchronization information.

27. The wakeup method of claim 26, wherein the synchronization information and the broadcast data packet are transmitted respectively through a beacon window and a broadcast window.
